(19) United States
(12) Patent Application Publication
(10) Pub. No.: US 2016/0165814 A1
(43) Pub. Date: Jun. 16, 2016

(54) Trellis System

(71) Applicant: David Parrish, Visalia, CA (US)

(72) Inventor: David Parrish, Visalia, CA (US)

(21) Appl. No.: 14/967,051

(22) Filed: Dec. 11, 2015

Related U.S. Application Data
(60) Provisional application No. 62/091,410, filed on Dec. 12, 2014.

(51) Int. Cl. A01G 17/06

(52) U.S. Cl. CPC A01G 17/06; A01G 2017/065

(57) ABSTRACT

The present invention provides an improved trellis system for use with low-lying row crops such as berries, tomatoes, peppers, peas, tomatoes, garlic and the like. The trellis systems of the present invention include a pair of end frames provided at opposite ends of a crop row, and one or more intermediate support frames provided along the row, all of the frames being constructed for easy insertion into and removal from the ground. Retaining lines are removably stretched between the end frames, and engaged with receivers on the intermediate frames without having to thread the lines through the receivers. One of each pair of end frames includes a plurality of tightening devices for applying tension to the retaining lines. The trellis systems of the present invention may be easily installed, removed, stored and reused.

This application claims the benefit of U.S. Provisional Patent Application No. 62/091,410 filed on Dec. 12, 2014, which is incorporated herein in its entirety by this reference.

### FIELD OF THE INVENTION

The present invention relates to trellis systems for supporting plant growth and more particularly to improved trellis systems that may include novel vertical growth supports that can be quickly and efficiently installed and removed, and methods of installing using, removing and storing the same.

### DISCUSSION OF THE BACKGROUND

Many plants show improved growth and production when they have vertical growth support that keeps them off of the ground (e.g., flowers, climbing and vining plants, etc.). It is desirable to support certain plants off of the ground to keep them clean, safe from the threat of animals and diseases, in a position that will attract pollinators, and to keep fruit off of ground to prevent fruit from rotting, etc. Trellis systems are commonly used for growing some vine fruits (e.g., grapes). However, conventional trellis systems have drawbacks for use with other types of crops (e.g., flowers, climbing and vining plants, etc.) because they are time-consuming and expensive to install; because they require sturdy vertical stakes at relatively close intervals to support and train the plants; and because they are not particularly suited for certain kinds of low-lying plants (e.g. raspberries, blueberries, boysenberries, tomatoes, peppers, peas, tomatoes, garlic, flowers, etc.).

Also, because of the temporary nature of the growing season in some areas, requiring the rotation or alternation of crops, it is advantageous to have growing structures that are easy to assemble, disassemble, store, and move. Many existing trellis systems are long-term semi-permanent structures that cannot be economically removed and assembled on a seasonal basis.

In addition to vineyard trellis systems, there are various combinations of poles, slats, cords and wires, as well as metal, concrete and wood structures are currently in use for growing various kinds of plants. However, systems that are currently used to maintain vertical growth of certain kinds of plants (e.g., bell peppers, tomatoes, flowers, onions, garlic, peas, etc.) have drawbacks that have not been addressed. For one, these systems are often difficult and time consuming to assemble. Typically, such systems include a single central set of posts with wires strung there-between on which the plants may be trellised and trained. These posts are typical individually installed at about five foot intervals, and must be driven a significant depth into the ground (e.g., two or more feet). Wires are then strung along the central posts by tying, stapling, or otherwise binding each wire to each of the individual posts, and the wire must be maintained under sufficient tension between the posts to maintain a taut wire that can support the plants. This is a very time-consuming process. Subsequently, a system of stakes and strings are set up laterally to the central posts along the perimeter of the row bed of the plants to act as a retaining system or barrier to prevent the plants from growing outwardly and to encourage them to grow vertically. The installation and removal of the central stake system and the stake and string system is very labor-intensive, time-consuming, and expensive, especially in a large growing operation. Such systems are also difficult to store due to the large volume of stakes that are required for large growing operations. Additionally, damage and wear is caused by stress and movement to the plant support systems during assembly and disassembly and while produce is being harvested.

While there are existing designs that are functional to support vertical plant growth, many have disadvantages that reduce their usefulness by being complicated, cumbersome, difficult to assemble and disassemble, and difficult to store. Additionally, some of the materials of these systems are not reusable, including the string and sometimes the stakes used in the retaining system. It is therefore desirable to provide a reusable trellis system that is more efficiently installed, removed, and stored, and methods of using the same.

### SUMMARY OF THE INVENTION

The present invention provides improved trellis system that offers significant improvements efficiency with regard to assembling and disassembling the system, storing the system, improving crop yields, and methods of using the same. The trellis system may be used for various vine and low-lying plants (e.g. raspberries, blue berries, boysenberries, tomatoes, peppers, peas, tomatoes, garlic, flowers, etc.) that can be advantageously grown in a trellis system. The trellis system may include multiple plant support frames that have a width that fits within a conventional crop row bed and that support vertical growth of the selected plants.

Embodiments of the trellis systems of the present invention may include a set of vertical support frames that may be installed in a crop row bed and connected by one or more plant retaining lines that are attached to the vertical support frames by retaining line receivers (e.g., a clip or other retaining device). Each vertical support frame may include two or more vertical members (e.g., two, three, or more vertical members), one or more horizontal members (e.g., two, three, or more), and a base horizontal member. The vertical members may be spaced apart from one another at a sufficient distance to provide structural stability to the vertical supports while providing a trellis system having a practical growing structure that is functional to promote vertical growth (e.g., in a range of about 6 inches to about 3 feet, or any value or range of values therein) of plants selected for cultivation within the trellis system. In some embodiments, and without limitation, the vertical members may each include two bars or poles (e.g., two rebars) to provide a stronger, reinforced structure. The horizontal members may be attached to the vertical members and may be spaced apart at intervals that allow for efficient training of the plant in a range of about 6 inches to about 3 feet (e.g., about 8 inches to about 24 inches, or any value or range of values therein). The base horizontal member may be positioned on the vertical members at a point to which the vertical members may be inserted into the ground. A bottom portion of the vertical member may serve as anchoring stakes intended to be inserted into the soil of the crop row to a certain depth, and the base horizontal member may be positioned such that it rests on the upper surface of the soil when the vertical members are inserted into the soil. The bottom portions of the vertical members may extend from the base horizontal member a relatively short distance (e.g., about 6 inches to about three feet, or any value or range of values therein) to allow the vertical support frame to be easily installed in the crop row. For example, the short length of the bottom portions may allow a person to quickly sink the vertical support frame in the soil by simply using the weight of his body (e.g., using his foot to push the base horizontal member toward the ground).

Retaining line receivers may be attached to the horizontal members and/or the vertical members through which the retaining lines may run when the trellis system is assembled. The retaining line receivers may keep the retaining lines in their designated positions and prevent the plants grown in the crop row from displacing the retaining lines (e.g., laterally and/or vertically). One or more of the retaining line receivers may be positioned at multiple positions on each horizontal member of each vertical support frame in the trellis system. The positions of the retaining line receivers (clips) on each of the vertical support frames may be arranged such that they are aligned when the vertical support frames are installed along a crop row, such that each of the retaining lines may be strung in a substantially straight line through aligned retaining line receivers. The retaining line receivers may have one or more incomplete or open rings or loops, rings or loops that may be opened and closed, or other receptacles through which the retaining lines can be strung. The open, incomplete, or openable configuration of the rings or loops allows each retaining line to be inserted into or otherwise engaged with the rings or loops without the need to longitudinally thread the retaining line through the receivers.

Each retaining line may be a high tensile strength line that is stretched along the crop row. Each retaining line is to be stretched between end frames of the trellis system, such that it is sufficiently taut to support plants growing in the crop row. The retaining lines may also function to keep the vertical support frames in proper position by being passed through the retaining line receivers. The retaining line(s) may be made from a durable material (e.g., high tensile strength plastic or polymer line, metal wire, composite line, etc.) that may be recovered for future use when the trellis system is disassembled. In preferred embodiments, the retaining lines may be either a galvanized 14 to 16 gauge steel wire, or a plastic multi strand 9 to 12 gauge wire. The retaining lines may be re-spooled from the ends when the trellis system disassembled and reused the next time the system is set up.

As mentioned above, the trellis system may also include end frames at each end of the crop row bed to which the ends of the retaining lines are attached. One of the end frames may anchor the retaining lines and the opposite end frame may include one or more ratchets or other cinching devices with which the retaining lines may be engaged. The cinching device may be used to tighten the retaining lines to a pre-determined tension that allows the retaining lines to remain tight and provide support to plants grown in the crop row bed. The tension on the retaining lines may also aid in keeping the vertical support frames in their intended vertical position, preventing the vertical support frames from leaning or falling. Each of the end frames may be anchored to an anchoring stake that is driven into the soil to a sufficient depth such that the tension in the retaining lines does not pull the end frames down. The end frames may be attached or anchored to the anchoring stake by a wire or other fastener.

The trellis systems of the present invention offer efficiencies in installation over conventional systems. The trellis systems of the present invention can be installed and assembled in a crop row without the need to set up an independent system of stakes and strings to retain the plants along the trellis, encourage them to grow vertically, and prevent them from falling or growing outwardly or laterally. The retaining lines of the present invention can be laid out lengthwise along the crop row, attached to the end frames, and subsequently attached to the vertical support frames. This avoids the need to install a second system of stakes or the need to sequentially tie the retaining lines to each vertical support frame. Thus, embodiments of the present invention save a substantial amount of time and man-hours in comparison to conventional trellising systems.

According to embodiments of the present invention, the retaining lines may be laid out along the entire crop row prior to, during, or after the installation of the vertical support frames. For example, the retaining lines can be spooled out from a tractor, truck, or other vehicle quickly and efficiently. Subsequently, the vertical support frames may be driven into the ground along the crop row to the point that the horizontal base members are resting on the soil, which may be done quickly without the need to drive the bottom portions of the vertical support frames deeply into the ground. One or more anchoring stakes (e.g., a metal stake) may be driven into the ground at each end of the crop row to provide an anchor to the trellis system. The anchoring stakes may be sufficiently driven into the ground to withstand the high tensile stress that will be applied to the retaining line (e.g., the stakes may be driven into the ground several feet and be angled away from the crop row). The end frames may be anchored to the anchoring stakes by one or more high-tensile strength cables or wires to provide a strong connection between the end frames and the anchoring stakes.

Once the vertical support frames, the end frames, and the anchoring stakes are in position, the retaining lines can then be attached to each end frame. One end of each retaining line may be tied or otherwise statically anchored to one of the end frames of a row, and the opposite end of the retaining line may be attached to one or more tightening devices (e.g., ratchets or other cinching devices) located on the other end frame at the opposite end of the row, which allows the retaining lines to be tightened to a preferred tension. Prior to tightening the retaining lines to the preferred tension, the lines may be placed into retaining line receivers on the vertical support frames that have been deployed along the row, which may maintain the position of the retaining lines along the crop row bed and aid in maintaining the position of the vertical support frames. Embodiments of the retaining line receivers on each vertical support frame may have one or more incomplete or open rings or loops or other receptacles through which the retaining lines can be strung. The open or incomplete configuration of the rings or loops allows each retaining line to be inserted into or otherwise engaged with the rings or loops without having to go through the process of longitudinally threading the retaining line through the receivers.

Once the retaining lines are positioned in the retaining line receivers, the retaining lines may be tightened to the desired tension using the cinching devices. In preferred embodiments, this tension may be 200 to 300 lbs. This places the vertical frames and the retaining lines in sturdy and weight-bearing condition, supported by the anchoring stakes. The retaining lines may be ratcheted or cinched to a desired tension by the tightening devices to which they are attached on the end frame. Once the desired tension is established the installation of the trellis system may be complete. Thereafter, as plants grow larger and crops mature, the weight they place on the trellis system may cause the retaining lines to sag. The trellis systems of the present invention are designed to allow these lines to be tightened during use to remove sag caused by weight placed on the lines as the crops grow to maturity.

In most embodiments, fewer vertical support frames are needed than the number of trellis system stakes that are used in conventional trellis systems. The high-tension retaining lines provide improved structural support that allows for relatively large gaps between adjacent vertical support frames. For example, the vertical support frames may be spaced apart by a distance ranging from about 10 feet to about 30 feet (e.g., about 15 feet to about 25 feet, or any value or range of values therein). In preferred embodiments, the support frames may be placed 15 to 30 feet apart, depending on the crop and crop load. This is in contrast to conventional systems that typically have stakes that are spaced apart at shorter intervals (e.g., about every five feet). Also, the vertical support frames do not need to be inserted into the soil as deeply as the trellis stakes of a conventional trellis system. The vertical support frames of the present invention may be inserted into the soil from a depth of about 6 inches to about 36 inches (which may depend on the height of the vertical support frames). The relatively small side profile vertical members of the vertical support frames and the relatively shallow depth to which they may be inserted allow them to be inserted into the soil relatively quickly. For example, and without limitation, the vertical frames may be installed without tools by the installer simply applying his weight to the horizontal base member. Thus, less time is spent assembling the trellis system due the quickness of establishing the vertical support frames in the crop row bed.

The present invention also provides efficiencies in storage of the trellis system. The vertical support frames of the present invention may be made from structural members (e.g., the vertical members and the horizontal members) that have a small side profile and/or thickness. For example, and without limitation, the horizontal and vertical members may be made from a high strength durable material, such as a metal (e.g., steel rebar, steel pipe, aluminum pipe, etc.) or another high-strength durable material. Because of the small number of vertical support frames and the small side profile of the vertical support frames, they may be stacked or otherwise stored in a relatively small volume. The retaining lines may be reusable, since they are not tied to the vertical support frames and can be easily disconnected from the end units and removed from the other vertical support frames. Once, disconnected, the retaining lines may be re-spooled from the ends for easier and quicker dismantling of the trellis. Many row crops are grown for only a few months, and then a new crop is replanted. Because of this, many fields will have the trellis erected and dismantled 4 times a year, making the dismantling and installation time critical. The trellis systems of the present invention can be quickly assembled and dismantled due to the relatively shallow anchoring of the vertical support frames and the threaded (rather than looped or tied) installation of the high tension retaining lines. Additionally, the low profile vertical supports and spoolable retaining lines allow for efficient storage when the trellis system is not being used, and all of the materials of the present invention can be stored and reused many times, which provides further economic efficiencies.

The advantages of the present invention are further illustrated by the embodiments described herein. It is to be understood that here are several variations in the trellis system, and that the embodiments described herein are presented for purposes of illustration and description. They are not intended to be exhaustive or to limit the invention to any of the specific embodiments disclosed.

In some embodiments, and without limitation, the present invention relates to a trellis system having two end frames for installation at opposite ends of the trellis system (e.g., at opposite ends of a crop row), where a first end frame has at least one tightening device located thereon; at least one intermediate support frame for installation between the two end frames, the intermediate support frame having at least one retaining line receiver located thereon; and at least one retaining line extending between the end frames, where a first end of each such retaining line is engaged with the at least one tightening device for applying tension to such retaining line, a second end of each such retaining line being attached to the other end frame, and the at least one retaining line receiver is engaged with the at least one of retaining line.

In some embodiments, and without limitation, the present invention relates to a trellis system that includes a first end frame and a second end frame for installation at opposite ends of the trellis system (e.g., opposite ends of a crop row), the first end frame including a plurality of line tightening devices thereon; a first anchoring stake and a second anchoring stake for installation at the opposite ends of the trellis system, the first anchoring stake being for installation adjacent to the first end frame and the second anchoring stake being for installation adjacent to the second end frame; a plurality of intermediate vertical support frames for installation between the first and second end frames, the plurality of intermediate support frames each including a plurality of retaining line receivers thereon;

and a plurality of retaining lines, each of the plurality of retaining lines having a first end that is statically attached to the second end frame and a second end that is attached to one of the tightening devices on the first end frame, with each tightening device applying tension to its respective retaining line. The retaining lines may be removably engaged with at least one receiver on multiple or all of the intermediate vertical support frames.

In some embodiments, and without limitation, the present invention relates to a trellis system that includes a first end frame positioned at one end of a crop row; a second end frame positioned at an opposite end of the crop row; at least one intermediate support frame positioned along the crop row between the first end frame and the second end frame; a plurality of retaining lines extending between the first end frame and the second end frame, each retaining line having a proximal end and an opposite distal end; a plurality of connectors located on the first end frame for engagement with the proximal ends of the retaining lines; a plurality of line-tightening devices located on the second end frame for engagement with the distal ends of the retaining lines and applying tension thereto; and a plurality of retaining line receivers located on each intermediate frame for removably receiving individual ones of the retaining lines.

In some embodiments, and without limitation, the present invention relates to a method of installing a trellis system, including laying out a plurality of retaining lines along a crop row; installing in the ground a plurality of vertical support frames along the crop row, each of the plurality of vertical support frames having a plurality of retaining line receivers thereon; installing a first end frame at a first end of the installed plurality of vertical support frames (e.g., at the first end of the crop row); installing a second end frame at a second end of the installed plurality of vertical support frames (e.g., at the second end of the crop row), where the second end frame includes a plurality of line-tightening devices thereon; attaching a first end of each of the plurality of retaining lines to the first end frame; attaching a second end of each of the plurality of retaining lines to one of the line-tightening devices of the second end frame; engaging each of the plurality of retaining lines with one of the retaining line receivers on each of the vertical support frames after the plurality of retaining lines are attached to the first end frame and the second end frame; and tightening the retaining lines using the line-tightening devices.

It is an object of the present invention to provide a trellis system that can be quickly and efficiently installed, removed and reused for growing trellised crops, without sacrificing structural integrity.

It is also an object of the present invention to provide a trellis system that includes high tension lines for retaining trellised crops and/or providing vertical support to the trellised crops.

It is also an object of the present invention to provide a trellis system that includes anchored end frame units that can hold up under high tension applied to retaining lines attached to the end frames.

It is also an object of the present invention to provide a trellis system that requires fewer trellises than a conventional trellis system, thereby reducing the installation and removal time of the trellis system.

It is also an object of the present invention to provide a trellis system that uses high tension retaining lines as the primary means of supporting trellised plants.

Additional aspects and objects of the invention will be apparent from the detailed descriptions and the claims herein.

### BRIEF DESCRIPTION OF THE DRAWINGS

FIG. 1 is a side view of a trellis system according to an embodiment of the present invention installed along a crop row in a field.

FIG. 2 is a close-up side view of an end frame of the trellis system of FIG. 1.

FIG. 3 is a close-up side view of an opposite end frame of the trellis system of FIG. 1.

FIG. 4 is an end view of an intermediate vertical support frame of a trellis system according to an embodiment of the present invention installed in the ground on a crop row showing the location of plants trellised on the system.

FIG. 5 is a side view of an intermediate vertical support frame of a trellis system according to an embodiment of the present invention installed in the ground.

FIG. 6 is an end view of an end frame of a trellis system according to an embodiment of the present invention installed in the ground.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

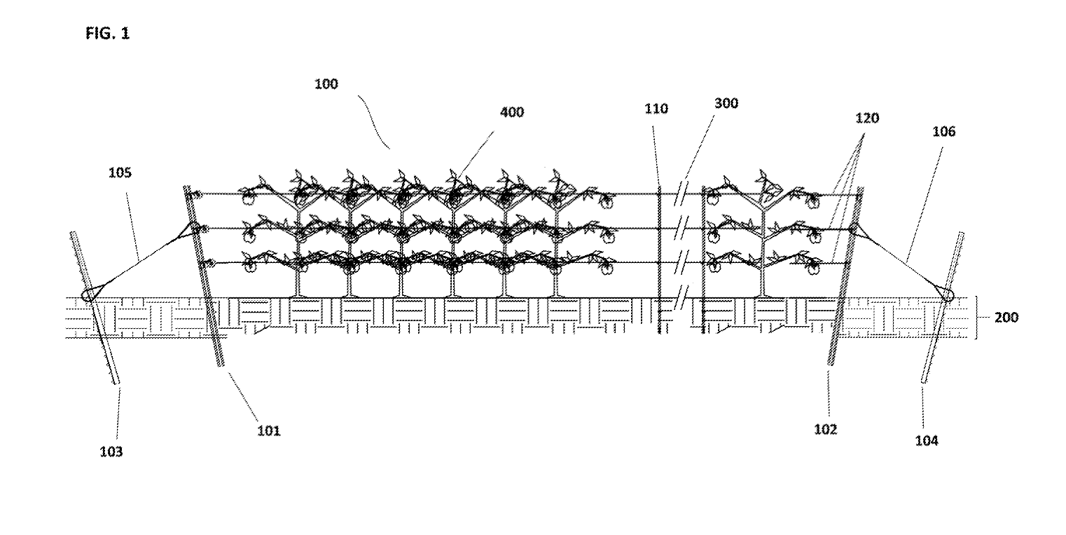

Referring to the drawings wherein like reference characters designate like or corresponding parts throughout the several views, and referring particularly to FIGS. 1-6, it is seen that the present invention includes various embodiments of a trellising system for supporting vertical growth of various plants and that may be efficiently assembled and disassembled.

Without limiting the invention, FIG. 1 shows an exemplary embodiment of a trellis system according to the present invention. Trellis system 100 is shown assembled and inserted into the ground 200 along a crop row. The illustrated trellis system includes a first end frame 101 and a second end frame 102, anchoring stakes 103 and 104 to which the end frames 101 and 102 are attached and anchored by tie-back lines 105 and 106, one or more intermediate vertical support frames 110, and one or more retaining lines 120. It should be understood that there is a break 300 in the side view of the trellis system provided by FIG. 1, it being understood that additional support frames 110 and longer retaining lines 120 may be provided between end frames 101 and 102. It is to be understood that embodiments of the trellis system of the present invention may be several tens to hundreds of feet in length and include multiple vertical support structures along its length. The exemplary trellis system 100 in FIG. 1 includes breaks 300 therein so that trellis system 100 can be practically presented on a single drawing sheet.

Plants 400 (e.g., bell peppers, tomatoes, flowers, onions, garlic, peas, etc.) are supported by the retaining lines 120 which help the plants maintain a generally vertical orientation during growth, and help keep crops from touching the ground200. The retaining lines 120 are designed for attachment at each end to the end frames 101 and 102. Embodiments of the end frames may have a double frame structure for added strength, where there are two vertical members at each lateral side of the end frame and the vertical members sandwich horizontal members that run through the doubled vertical members. These vertical members may be bonded to each other and/or to the horizontal members by welding, brackets, and/or other methods of securement.

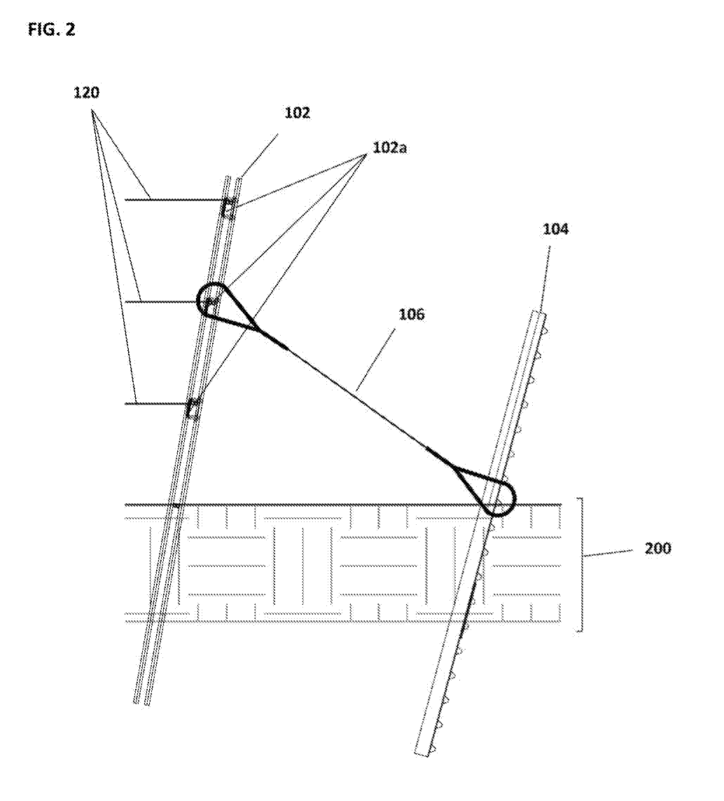

FIG. 2 provides a close up view of the end frame 102, and the attachment of the retaining lines 120 thereto. The retaining lines 120 may be coupled to the end frame 102 using attachment devices 102a(e.g., brackets, hooks, etc.); or the retaining lines 120 may be simply fixed or tied to the attachment devices 102a. Slack in retaining lines 120may be taken up at the opposite end where lines 120 attach to line-tightening devices 101a on end frame 101.

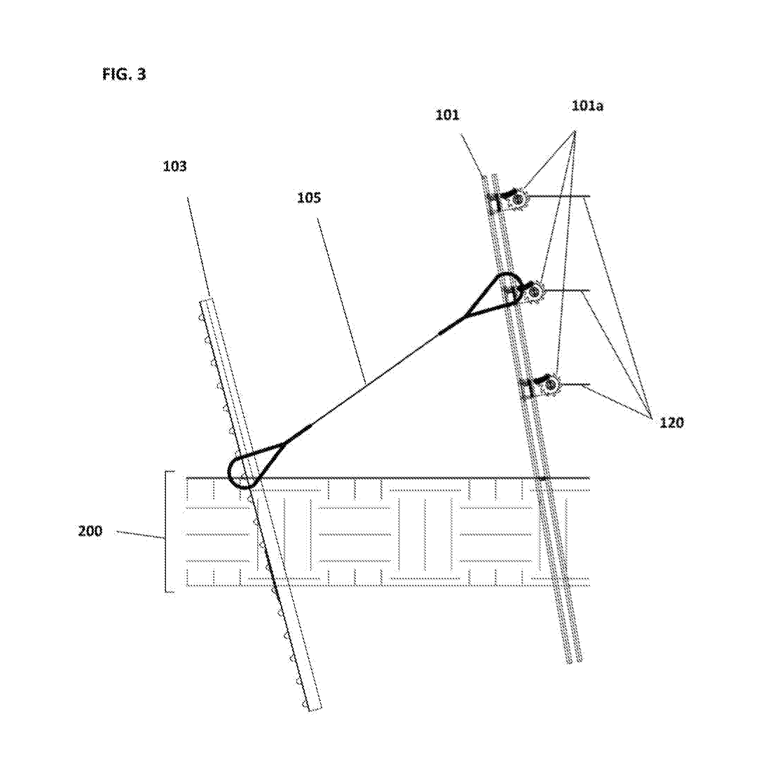

As shown in FIG. 3, the retaining lines 120 may be attached to the opposite end frame 101 using line-tightening devices 101a. Without limiting the invention, the tightening devices 101a may be ratcheting or cranking devices that allow a user of the trellis system to apply substantial tension to the retaining lines 120.

The retaining lines may be made from a material that allows the application of tension in a range of about 50 lbs. to about 2000 lbs. (e.g., about 100 to about 1000 lbs., or any value or range of values therein), with typical use in the range of 200 to 300 lbs. For example, and without limitation, the retaining lines 120 may be made from a high-tensile strength wire (e.g., high strength, high tensile steel, etc.), polymer material (e.g., carbon fibers, aromatic polyamide fibers, PBO, etc.), composite material, etc. In preferred embodiments, the retaining lines may be either a galvanized 14 to 16 gauge steel wire, or a plastic multi strand 9 to 12 gauge wire.

The tightening devices 101a are used to tighten the retaining lines 120 sufficiently to suspend the retaining lines with substantially no sag when the plants 400 are present and resting on the retaining lines 120. The tightening devices may include a manual or motorized cranking tool, in-line compression wire strainer, barrel-style strainer, or other leverage device (not shown) to apply the preferred tension to the retaining lines. The tightening devices 101a may be attached to the end frame 101 by brackets or other fasteners.

The tension applied to the retaining lines 120 may require that the end frames be strongly secured. An anchoring device may therefore be attached to each of the end frames in order to prevent the end frames from being uprooted or collapsing toward one another when tension is applied to the retaining lines 120. Without limiting the invention, FIGS. 1-3 show end frames 101 and 102 anchored to anchoring stakes 103 and 104, respectively, using tie back lines 105 and 106. The anchoring stakes may be driven several feet into the ground in order to withstand the tension applied to the end frames by the tightened retaining lines 120. The anchoring stakes 103 and 104 may also include features that prevent them from being uprooted themselves. For example, and without limitation, the anchoring stakes may include one or more plates along the buried portion thereof that are positioned perpendicularly or nearly perpendicularly to the tie back lines 105 and 106 to provide more surface area against the soil. For example, the anchoring stakes may be tee posts with foot plates attached thereto.

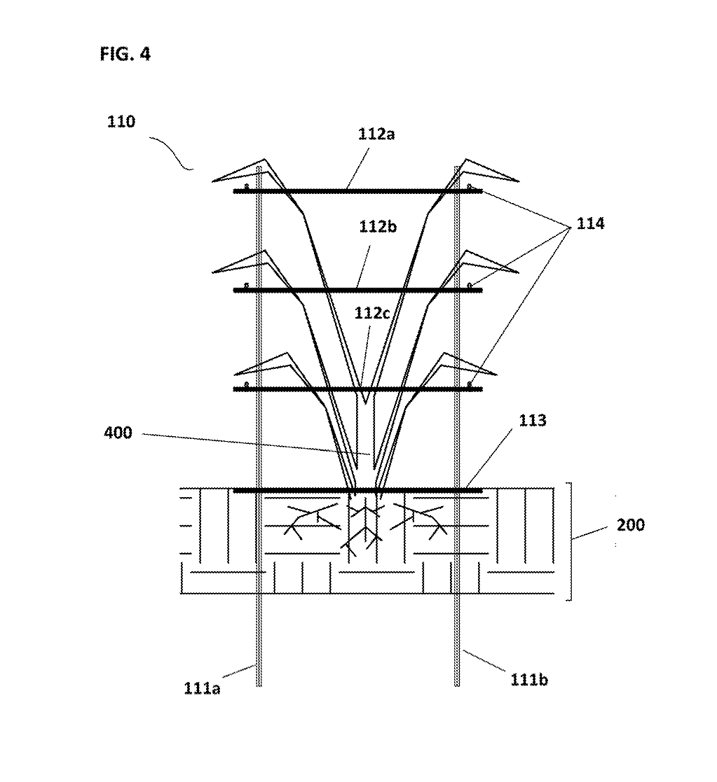

Between the end frames, a plurality of intermediate vertical support frames 110 may be set up in a crop row and spaced at regular or varying distances, depending upon such variables as, without limitation, the length and width of the row, the anticipated size and height of the plants, and the expected weight of the crop. For example, and without limitation, the vertical support frames 110 may be spaced apart by a distance in a range of about 10 feet to about 40 feet (e.g., about 15 to about 30 feet, about 20 to about 25 feet, or any value or range of values therein). The vertical support frames may have one or more vertical members and two or more horizontal members in the support frame structure, where the horizontal member may both connect with the retaining lines and provide vertical support to the plants grown in the crop row. Without limiting the invention, FIG. 4 provides an end view of an exemplary vertical support frame 110 having two vertical members 111a and 111b, three horizontal members 112a, 112b, and 112c, and a horizontal base member 113. The horizontal members 112a, 112b, and 112c may be spaced apart at regular intervals (e.g., in a range of about 4 inches to about 18 inches, or any value or range of values therein). In other implementations, the horizontal members may be spaced apart at varying intervals. The horizontal base member 113 may be included in the frame to set a depth to which the vertical frame may be inserted into the ground. The vertical frame 110 may be inserted into the ground to a depth such that the horizontal base member 113 may rest on the surface of the soil in a crop row.

Each of the horizontal members of an intermediate vertical support frame 110 may include retaining line receivers (e.g., clips, rings, etc.) 114 on or near their lateral ends. Without limiting the invention, the exemplary vertical support frame 110 shown in FIG. 4 includes retaining line receivers 114 at both lateral ends of each of the horizontal members 112a, 112b, and 112c. However, it is to be understood that the position of the retaining line receivers may be varied. For example, the retaining line receivers may be positioned on the outer side of the vertical support members. The retaining lines 120 may be strung through the retaining line receivers 114 to help support the vertical support frames in their positions along the crop row and to maintain the positions of the retaining lines 120 on the vertical support frames 110 so that they are in proximity to plants 400 and provide a growing scaffold for the plants. The retaining line receivers 114 may have one or more incomplete or open rings or loops through which the retaining lines can be strung. In some embodiments, and without limitation, the retaining line receivers may have one or more spiral loops (e.g., two with opposite spirality, like two ram's horns). The open or incomplete configuration of the rings or loops allows the retaining lines 120 to be inserted in the rings or loops without having to go through the process of longitudinally threading the retaining lines through the receivers 114. In other embodiments, and without limitation, the retaining line receivers may be closable clips that allow retaining line to pass freely therethrough (e.g., having a similar shape to carabiner clips, alligator clips, or other closable clip designs).

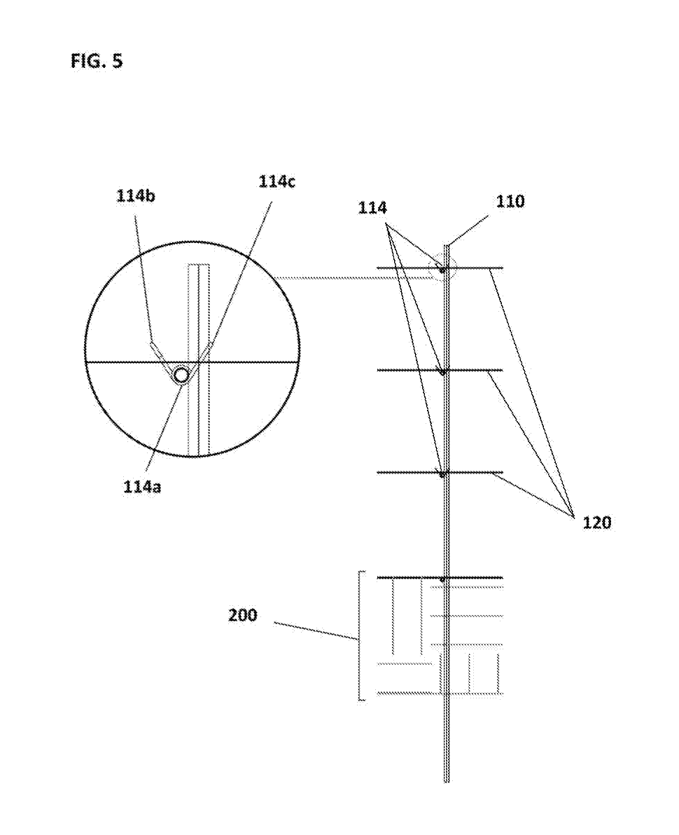

Without limiting the invention, FIG. 5 shows a side view of an exemplary embodiment of an intermediate vertical support frame 110 of the present invention, including the retaining line receivers 114. The retaining line receivers may include a fastener (e.g., a spring clip collar, bolt or clamp) for attaching the receiver to the horizontal member, or the retaining line receivers may be fused to the vertical support frame (e.g., by welding). For example, and without limitation, the retaining line receivers 114 may include a ring fastener 114a for attaching the receiver to the horizontal member. The retaining line receivers may also include one or more retaining line retainers for engagement with the retaining lines. For example, and without limitation, the exemplary retaining line receivers 114 illustrated in the enlarged area of FIG. 5 include two retainers 114b and 114c through which a retaining line 120 may pass. The retainers 114b and 114c may be open loops that allow a retaining line 120 to be routed through the retainers 114b and 114c without the need to thread the end of the retaining line 120 through the retainers 114b and 114c. The “open-loop” structure of the retainers allows the retaining lines to be laid out along the crop row and attached to the end frames before being inserted into the retainers of the retaining line receivers. The avoidance of having to thread the ends of the retaining lines through the retaining line receivers saves a substantial amount of labor and time in the process of installing or removing the trellis system. Once the retaining lines are routed through the retaining line receivers, the retaining lines may be tightened using the line tightening devices 101a to a preferred tension thereby providing scaffolding upon which the plants in the crop row may be supported during growth.

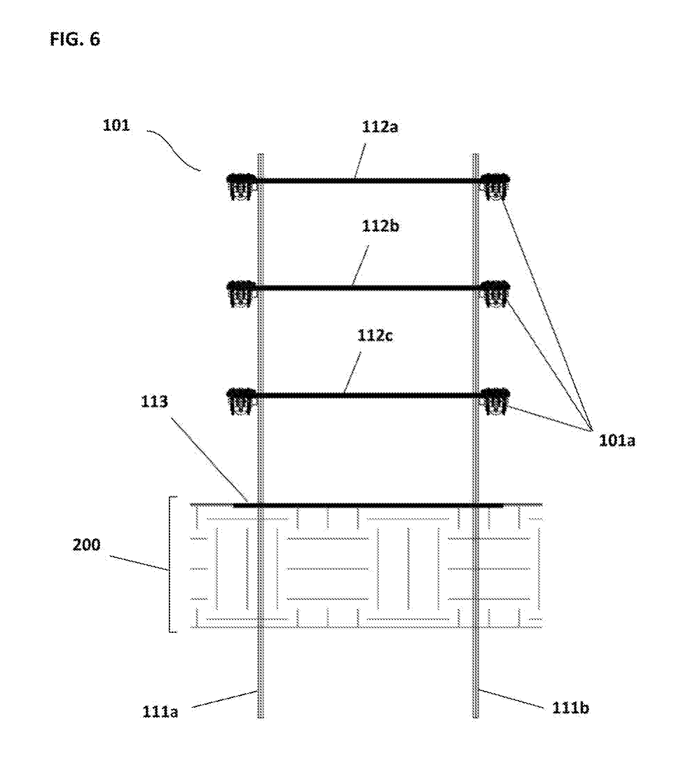

Without limiting the invention, FIG. 6 provides an end view of an exemplary end frame 101. Like the intermediate frames 110, the end frame 101 may have two vertical members 111a and 111b, three spaced horizontal members 112a, 112b, and 112c, and a horizontal base member 113. Also like the intermediate frames 110, the end frame 101 may be inserted into the ground to a depth such that the horizontal base member 113 may rest on the surface of the soil in a crop row. The other end frame 102 may have a similar structure as well. Rather than retaining line clips, the end frame 101 may include line-tightening devices 101a at each lateral end of each horizontal member 112a, 112b, and 112c. In other embodiments, and without limitation, the position of the retaining line receivers may be varied. For example, the retaining line receivers may be positioned on the outer side of the vertical support members. The line-tightening devices may be fixed to the end frame 101 by fasteners such as fastening loops, clamps, or brackets capable of maintaining the connection between the line-tightening devices 101a and the end frame 101 under high tension 50 lbs. to about 2000 lbs. of tension (e.g., about 100 to about 1000 lbs., or any value or range of values therein). The tightening devices may include a manual or motorized cranking tool, in-line compression wire strainer, barrel-style strainer, or other leverage device to apply the preferred tension to the retaining lines.

The present invention provides a trellis system that may be laid out in a more efficient way than conventional trellis systems, while still being structurally sound. According to methods of the present invention, the retaining lines 120 may be laid out along an entire crop row prior to, during, or after the installation of the vertical support frames 110, the end frames 101 and 102, and the anchoring stakes 103 and 104. For example, the retaining lines 120 may be spooled out along the crop row from a tractor, truck, or other vehicle quickly and efficiently without having to thread the ends of the retaining lines through the retaining line receivers 114. The vertical support frames 110 and end frames 101 and 102 may be driven into the ground either before or after the retaining lines 120 are laid out. The vertical support frames 110 and end frames 101 and 102 may be inserted into the soil along the crop row bed to the point that the horizontal base members 113 are resting at the surface of the soil 200.

The anchoring stakes 103 and 104 may be driven into the ground at each end of the crop row to provide anchors to the trellis system 100. The anchoring stakes 103 and 104 may be sufficiently driven into the ground to withstand the high tensile stress that will be applied to the retaining lines 120. For example, and without limitation, the stakes may be driven into the ground several feet (e.g., to a depth in a range of about two feet to about five feet, or any value or range of values therein) and be angled away from the crop row. The end frames 101 and 102 may be anchored to the anchoring stakes 103 and 104 by high-tensile strength cables 105 and 106 to provide a strong connection between the end frames and the anchoring stakes, as shown in FIGS. 2 and 3. Embodiments of cables 105 and 106 may have looped ends for ease of connection between the end frames and the anchoring stakes. One looped end may be looped around a horizontal member of the end frame, and the other looped end may be easily passed over the upper end of the anchoring stake prior to tightening the retaining lines 120.

Once the vertical support frames 110, the end frames 101 and 102, and the anchoring stakes 103 and 104 are in position, the retaining lines 120 can be attached to each end frame 101 and 102. One end of each of the anchoring lines 120 may be tied or otherwise statically anchored to end frame 102, and the opposite end of each retaining line 120 may be attached to one of the tightening devices 101a on opposite end frame 101, which allow the retaining lines 120 to be tightened to a preferred tension.

Prior to tightening the retaining lines 120 to the preferred tension, the lines may be placed into the retaining line receivers 114 on the vertical support frames 110, which may maintain the position of the retaining lines 120 along the crop row and aid in maintaining the position of the vertical support frames 110. The retaining line receivers 114 may have one or more open loop or openable retainers 114b and 114c through which the retaining lines 120 can be passed. The open loop or openable configuration of the retainers 114b and 114c allows the string to be inserted in the rings, loops, or clips of the retainers without having to go through the process of longitudinally threading the retaining line through the retainers.

Once the retaining lines 120 are positioned in the retaining line receivers 114, the retaining lines 120 may be tightened to the desired tension using the tightening devices 101a to establish the vertical frames 110 and the retaining lines 120 in a sturdy and weight-bearing condition. Once the desired tension is established the installation of the trellis system 100 may be complete.

Once the trellis system is installed and the retaining lines are tightened, the crops may be grown and trained (e.g., manually placed on the retaining lines and vertical support frames) throughout the growing season so that the plants are maintained in a vertical posture. FIG. 1 and FIG. 4 each show the plants 400 growing in a vertical orientation, maintained between the retaining lines 120.

The design of the trellis system of the present invention requires fewer vertical support structures (trellises) than are used in conventional trellis systems. The high-tension retaining lines provide added structural support that allows for relatively large gaps between adjacent vertical support frames. For example, the vertical support frames may be spaced apart by a distance in a range of about 10 feet to about 40 feet (e.g., about 15 feet to about 25 feet, or any value or range of values therein). Also, the vertical support frames 110 do not need to be inserted into the soil as deeply as the trellis stakes of a conventional trellis system. The vertical support frames 110 of the present invention may need to be inserted into the soil to a depth of about 6 inches to about 36 inches (depending on the height of the vertical support frames). The relatively small side profile vertical members of the vertical support frames and the relatively shallow depth to which they are inserted may allow them to be inserted into the soil quickly. For example, and without limitation, the vertical frames may be installed without tools and simply by the installer to by applying his weight to the horizontal base member.

The present invention provides a trellis system and methods of installing and removing the same that requires less time than conventional systems, without sacrificing the structural integrity of the trellis system. It is to be understood that there are several variations in the trellis system, and that the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A trellis system, comprising:
a. two end frames for installation at opposite ends of the trellis system, wherein a first of said end frames has at least one tightening device located thereon;
b. at least one intermediate support frame for installation between said two end frames, said at least one intermediate support frame having at least one retaining line receiver located thereon; and
c. at least one retaining line extending between said end frames, wherein a first end of said at least one retaining line is engaged with said at least one tightening device for applying tension to at least one retaining line, a second end of said at least one retaining line is attached to the other of said end frames, and said at least one retaining line receiver is for engaging with said at least one retaining line.

2. The system of claim 1, wherein each said at least one retaining line has a high tensile strength.

3. The system of claim 1, wherein said at least one retaining line receiver includes at least one open-loop retainer thereon for receiving said at least one retaining line.

4. The system of claim 1, further comprising a plurality of retaining lines, and further comprising a plurality of tightening devices on said first end frame, wherein each of said plurality of retaining lines is for attachment to a separate one of said plurality of tightening devices.

5. The system of claim 1, further comprising two anchoring stakes, one of said anchoring stakes being provided at each end of said trellis system adjacent to one of said end frames.

6. The system of claim 5, wherein each of said end frames is attached to one of said anchoring stakes.

7. The system of claim 6, wherein said end frames are each attached to said anchoring stakes by a high-tensile strength cable or wire.

8. The trellis system of claim 1 wherein each of said end frames, and each intermediate support frame comprise at least two vertical members and at least two horizontal members, wherein the horizontal members extend between and are connected to said vertical members such that a portion of each of said vertical members extends downward for insertion into soil.

9. The trellis system of claim 8, wherein said portion of each of said vertical members inserts shallowly into the soil, and said at least one intermediate support frame is supported and maintained in position in the trellis system by both said portions of said vertical members and said at least one retaining line.

10. A trellis system, comprising:
a. a first end frame and a second end frame for installation at opposite ends of a crop row, said first end frame comprising a plurality of line tightening devices thereon;
b. a first anchoring stake and a second anchoring stake for installation at said opposite ends of said crop row, adjacent to said first end frame and said second end frame, respectively;
c. a plurality of intermediate support frames for installation between said first and second end frames, each of said plurality of intermediate support frames including a plurality of retaining line receivers thereon; and
d. a plurality of retaining lines, each of said plurality of retaining lines having a first end that is engaged with one of said tightening devices on said first end frame and a second end that is fixedly attached to said second end frame.

11. The system of claim 10, wherein each of said plurality of retaining lines has a high tensile strength.

12. The system of claim 10, wherein each of said plurality of retaining line receivers includes at least one open-loop retainer thereon for receiving at least one of said plurality of retaining lines.

13. The system of claim 10, wherein said first and second end frames are each attached to said first and second anchoring stakes by a high-tensile strength cable or wire.

14. The trellis system of claim 10 wherein each of said end frames, and each intermediate support frame comprise at least two vertical members and at least two horizontal members, wherein the horizontal members extend between and are connected to said vertical members such that a portion of each of said vertical members extends downward for insertion into soil.

15. The trellis system of claim 14, wherein said portion of each of said vertical members inserts shallowly into the soil, and said at least one intermediate support frame is supported and maintained in position in the trellis system by both said portions of said vertical members and said plurality of retaining lines.

16. A trellis system comprising:
a. a first end frame positioned at one end of a crop row;
b. a second end frame positioned at an opposite end of said crop row;
c. at least one intermediate support frame positioned along said crop row between said first end frame and said second end frame;
d. a plurality of retaining lines extending between said first end frame and said second end frame, each retaining line having a proximal end and an opposite distal end;
e. a plurality of connectors located on said first end frame for engagement with said proximal ends of said retaining lines;
f. a plurality of line-tightening devices located on said second end frame for engagement with said distal ends of said retaining lines and applying tension thereto; and
g. a plurality of retaining line receivers located on each intermediate frame for removably receiving individual ones of said retaining lines.

17. The trellis system of claim 16 wherein said first end frame, said second end frame, and each intermediate frame comprise at least two vertical members and at least two horizontal members, wherein the horizontal members extend between and are connected to said vertical members such that a portion of each of said vertical members extends downward for insertion into soil.

18. The trellis system of claim 16 further comprising a first anchoring stake located adjacent to said first end frame, a second anchoring stake located adjacent to said second end frame, at least one tie line for engaging said first anchoring stake to said first end frame, and at least one additional tie line for engaging said second anchoring stake to said second end frame.

19. The trellis system of claim 16, wherein said retaining line receivers are open loop structures that allow at least one of said plurality of retaining lines to be inserted into the retaining line receivers after the proximal and distal ends of the retaining lines are attached to said first and second end frames.

20. A method of installing a trellis system, comprising:
a. laying out a plurality of retaining lines along a crop row;
b. installing in the ground a plurality of vertical support frames along the crop row, each of said plurality of vertical support frames having a plurality of retaining line receivers thereon;
c. installing a first end frame at a first end of the crop row and a second end frame at a second end of the crop row, wherein said second end frame includes a plurality of line-tightening devices thereon;
d. attaching a first end of each of said plurality of retaining lines to said first end frame;
e. attaching a second end of each of said plurality of retaining lines to one of said line-tightening devices on said second end frame;
f. engaging each of said plurality of retaining lines with one of said retaining line receivers on each of said vertical support frames after said plurality of retaining lines are attached to said first end frame and said line-tightening devices on said second end frame; and
g. tightening said retaining lines using said line-tightening devices.

21. The method of claim 20, wherein each of said plurality of retaining lines has a high tensile strength.

22. The method of claim 20, wherein each of said plurality of retaining line receivers includes at least one open-loop retainer thereon for receiving at least one of said plurality of retaining lines.

23. The method of claim 20, wherein said first and second end frames are each attached to an anchoring stake by a high-tensile strength cable or wire.

24. The method of claim 20, wherein said portion of each of said plurality of vertical support frames includes at least two vertical members and at least two horizontal members, wherein the horizontal members extend between and are connected to said vertical members such that a lower portion of each of said vertical members extends downward for insertion into soil, and said vertical members insert shallowly into the soil, such that each of said plurality of vertical support frames is supported and maintained in position in the trellis system by both said lower portions of said vertical members and said plurality of retaining lines.
